(19) United States
(12) Patent Application Publication
(10) Pub. No.: US 2026/0301704 A1
(43) Pub. Date: Oct. 1, 2026

(54) DISPLAY DEVICE AND DRIVING METHOD THEREOF

(71) Applicant: LG DISPLAY CO., LTD., Seoul (KR)

(72) Inventors: Chan Soo PARK, Paju-si (KR); Cheol Woo PARK, Paju-si (KR); Dae Hyun NAM, Paju-si (KR); Gyu Sik WON, Paju-si (KR)

(21) Appl. No.: 19/436,854

(22) Filed: Dec. 30, 2025

(30) Foreign Application Priority Data
Mar. 28, 2025 (KR) 10-2025-0039978

(51) Int. Cl. G09G 3/36

(52) U.S. Cl. CPC G09G 3/3614; G09G 2310/08; G09G 2320/0233; G09G 2340/0435

(57) ABSTRACT

A display device including a first pixel area configured to display an image at a first refresh rate, and a second pixel area configured to display an image at a second refresh rate lower than the first refresh rate. During a frame period in which pixel data is updated for the pixels in the second pixel area, the polarity of the data voltage is inverted. A driving method using the display device is also disclosed.

### CROSS-REFERENCE TO RELATED APPLICATION

This application claims priority from and the benefit of Korean Patent Application No. 10-2025-0039978, filed Mar. 28, 2025, which is hereby incorporated by reference for all purposes as if fully set forth herein.

### BACKGROUND

### Field

Embodiments of the invention relate generally to a display device supporting a Variable Refresh Rate (VRR) and a driving method thereof.

### Discussion of the Background

Recently, display devices can support a Variable Refresh Rate (VRR). A variable refresh rate can variably change the frame update rate per second of images reproduced on the screen of the display device in real time, rather than maintaining it at a fixed value. A variable refresh rate can address problems, such as tearing or stuttering of images reproduced on the screen by adjusting the driving frequency of pixels to match the frames per second (FPS) of input images in content such as games or animations. However, when pixels are driven at a variable refresh rate according to the driving characteristics of the display device, unexpected image quality degradation may be perceived. For example, when a portion where an image is displayed at a high refresh rate and a portion where an image is displayed at a low refresh rate are visible together on the screen, a luminance difference between pixel areas having different refresh rates may be perceived.

The above information disclosed in this Background section is only for understanding of the background of the inventive concepts, and, therefore, it may contain information that does not constitute prior art.

### SUMMARY

A display device and a driving method thereof according to embodiments are capable of preventing perception of luminance differences at boundaries between pixel areas having different refresh rates when pixels are driven at a variable refresh rate.

Additional features of the inventive concepts will be set forth in the description which follows, and in part will be apparent from the description, or may be learned by practice of the inventive concepts.

According to one or more embodiments of the invention, a display device includes a display panel including a plurality of data lines, a plurality of gate lines, and a plurality of pixels; a data driver electrically connected to the plurality of data lines and configured to output a data voltage having a polarity indicated by a polarity control signal; a gate driver electrically connected to the plurality of gate lines and configured to output a gate pulse synchronized with the data voltage; and a timing controller configured to control operation timing of the data driver and the gate driver, and to generate the polarity control signal to control polarities of the plurality of pixels. The display panel includes a first pixel area configured to display an image at a first refresh rate and a second pixel area configured to display an image at a second refresh rate lower than the first refresh rate. During a frame period in which pixel data is updated for the pixels in the second pixel area, the polarity of the data voltage is inverted.

During a frame period in which pixel data is updated for the pixels in the second pixel area, the polarities of the pixels in the first pixel area and the pixels in the second pixel area may be inverted.

During a frame period in which pixel data is updated for the pixels in the first pixel area and the second pixel area, the polarities of the pixels in the first pixel area and the second pixel area may be maintained.

During a frame period in which pixel data is updated only in the first pixel area, the polarities of the pixels in the first pixel area and the second pixel area may be maintained.

The data driver may output the data voltage during a refresh period of a frame period in which pixel data is updated in the first pixel area and the second pixel area, and not output the data voltage during a skip period in which pixel data is not updated.

The data driver may output the data voltage having a first polarity through odd-numbered output terminals and output the data voltage having a second polarity through even-numbered output terminals, and invert the polarity of the data voltage output through the odd-numbered output terminals and the polarity of the data voltage output through the even-numbered output terminals in response to the polarity control signal during the frame periods in which pixel data is updated for the pixels in the second pixel area.

A driving frequency of pixels arranged in the second pixel area may be less than a driving frequency of pixels arranged in the first pixel area.

A polarity inversion frequency of pixels arranged in the second pixel area may be substantially equal to a polarity inversion frequency of pixels arranged in the first pixel area.

The plurality of pixels may include liquid crystal.

Frequencies of the first refresh rate and the second refresh rate may be different from each other.

According to yet another embodiment of the invention, a method of driving a display device includes driving pixels in a first pixel area of a screen of the display device at a first driving frequency to display images in the first pixel area at a first refresh rate; driving pixels of a second pixel area of the screen at a second driving frequency to display images in the second pixel area at a second refresh rate lower than the first refresh rate; and inverting polarities of the pixels in the first pixel area and the pixels in the second pixel area during a frame period in which pixel data is updated for the pixels in the second pixel area.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a block diagram showing a display device according to an embodiment of the invention.

FIG. 2 is an equivalent circuit diagram showing an example of a pixel circuit.

FIG. 3 is an equivalent diagram showing an example of the data driver shown in FIG. 1.

FIG. 4 is a diagram showing an example where pixels are driven at multiple

frequencies when one frame image signal is displayed on the screen of a display panel.

FIG. 5 is a diagram showing a polarity control method according to an embodiment of the invention.

FIG. 6 is a timing diagram showing an example where the polarity of data voltage is inverted every frame period.

FIG. 7 is a diagram showing a polarity control method according to another embodiment of the invention.

FIG. 8 and FIG. 9 are diagrams showing an example of data voltage waveforms applied to data lines in the polarity control method shown in FIG. 7.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

In the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As is customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

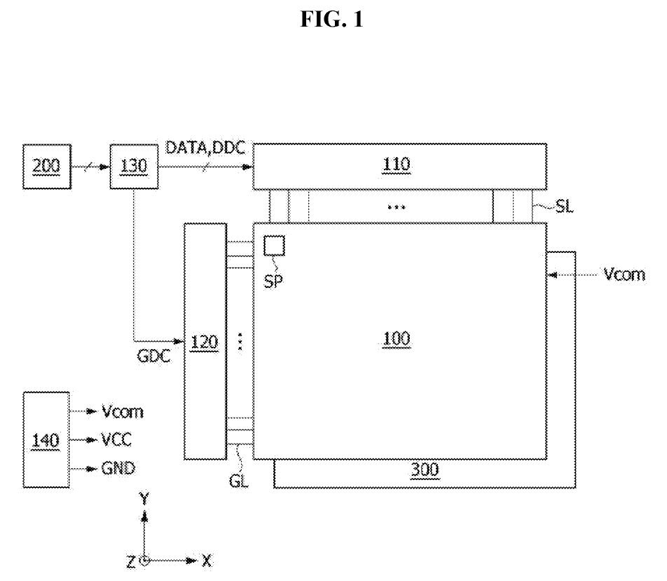

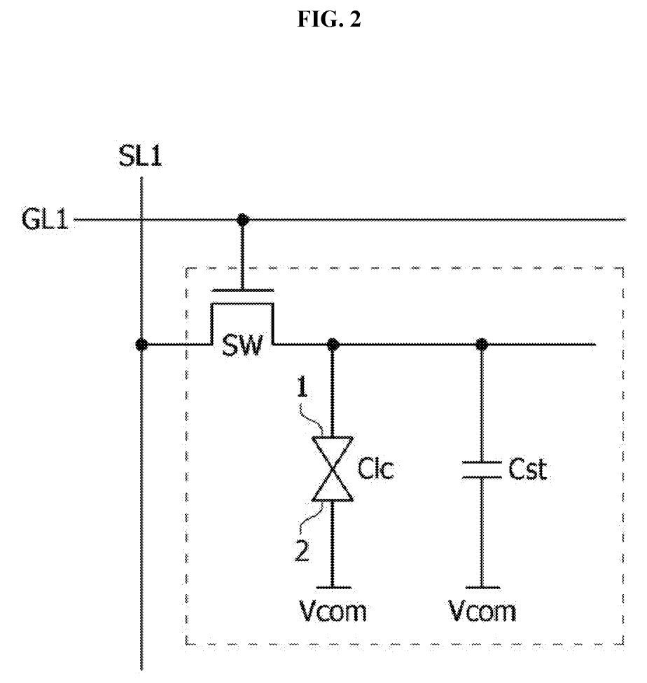

FIG. 1 is a diagram showing a display device according to an embodiment of the invention. FIG. 2 is an equivalent circuit diagram showing an example of a pixel circuit.

Referring to FIGS. 1 and 2, a display device according to an embodiment of the invention includes a display panel 100, a timing controller 130, a data driver 110, and a gate driver 120.

The display panel 100 may be a rectangular panel having a width in the X-axis direction (or first direction), a length in the Y-axis direction (or second direction), and a thickness in the Z-axis direction (or third direction), but is not limited thereto. In some embodiments, the display panel 100 may have square, circular, elliptical, or polygonal planar shape, and may include rounded corners, beveled edges, or an irregular outline. The display panel 100 may also be implemented as a curved panel having curvature in one or more directions, or as a flexible, bendable, foldable, or rollable panel. The display panel 100 includes a screen on which input images are displayed. The screen of the display panel 100 includes a pixel array for displaying input images. The pixel array includes a plurality of data lines SL, a plurality of gate lines GL crossing the data lines SL, and pixels arranged in a matrix form.

The data lines SL are arranged in the form of long wiring along the Y-axis direction of the display panel 100 and are electrically connected to output terminals of the data driver 110. The gate lines GL are arranged in the form of long wires along the X-axis direction of the display panel 100, cross the data lines SL, and are electrically connected to output terminals of the gate driver 120.

The display panel 100 may include a liquid crystal layer sandwiched between two transparent substrates. The pixels of the display panel 100 may include a portion of the liquid crystal layer as liquid crystal cells Clc. Each of the pixels may be divided into a red sub-pixel, a green sub-pixel, and a blue sub-pixel for color implementation. In FIG. 1, 'SP' represents a sub-pixel. Each of the pixels may further include a white sub-pixel. Each pixel circuit is electrically connected to a data line SL1 and a gate line GL1 as shown in FIG. 2. The pixel circuit may be implemented as the circuit shown in FIG. 2, but is not limited thereto.

Each of the sub-pixels SP includes a thin film transistor (TFT) SW used as a switch element, a storage capacitor Cst, and a liquid crystal cell Clc as shown in FIG. 2. The TFT SW includes a gate electrode electrically connected to the gate line GL1, a source electrode electrically connected to the data line SL1, and a drain electrode electrically connected to a pixel electrode 1. The storage capacitor Cst is electrically connected between the pixel electrode 1 and a common electrode 2 to maintain the voltage applied to the liquid crystal cell Clc. The liquid crystal cell Clc is sandwiched between the pixel electrode 1 and the common electrode 2 and includes liquid crystal molecules driven according to the voltage applied to the pixel electrode 1.

A TFT array is formed on a lower substrate of the display panel 100. The TFT array includes liquid crystal cells Clc formed at intersections of the data lines SL and the gate lines GL, TFTs electrically connected to the pixel electrodes 1 of the liquid crystal cells, and the storage capacitors Cst. The liquid crystal cells Clc are electrically connected to TFTs and driven by electric fields between the pixel electrodes 1 and the common electrode 2. A color filter array including a black matrix, color filters, etc. may be formed on an upper substrate of the display panel 100, but is not limited thereto. For example, the black matrix and color filters may be disposed on the TFT array of the lower substrate. Polarizing plates are attached to each of the upper substrate and lower substrate of the display panel 100, and alignment films are formed to set the pre-tilt angle of liquid crystal.

The common electrode 2 is formed on the upper substrate in vertical field driving methods such as TN (Twisted Nematic) mode and VA (Vertical Alignment) mode, and is formed on the lower substrate together with the pixel electrode 1 in horizontal field driving methods such as IPS (In Plane Switching) mode and FFS (Fringe Field Switching) mode.

The display panel 100 may be implemented in any liquid crystal mode, not only TN mode, VA mode, IPS mode, and FFS mode. The liquid crystal display device may be implemented in any form such as a transmissive liquid crystal display device, a transflective liquid crystal display device, or a reflective liquid crystal display device. A backlight unit 300 is required for transmissive liquid crystal display devices and transflective liquid crystal display devices. The backlight unit 300 may be implemented as a direct type backlight unit or an edge type backlight unit.

The timing controller (TCON) 130 transmits pixel data (or video data) of input images input from a host system 200 to the data driver 110. The pixel data is digital data. The timing controller 130 receives timing signals such as vertical synchronization signal Vsync, horizontal synchronization signal Hsync, data enable signal DE, and clock CLK. The timing controller 130 synchronizes the data driver 110 and the gate driver 120 based on the timing signals and generates timing control signals DDC and GDC for controlling the operation timing of each of these drivers 110 and 120. The vertical synchronization signal Vsync defines one frame period. The horizontal synchronization signal Hsync and the data enable signal DE have a period of one horizontal period. The data enable signal DE defines a valid data period in which video data of the input image exists. One horizontal period is the time for sub-pixels of one pixel line in the display panel 100 to charge data voltage in synchronization with gate pulses. One horizontal period is the time obtained by dividing one frame period by the total number of pixel lines of the display panel.

The gate timing control signal GDC includes gate start pulse, gate shift clock, etc., and may be input to the gate driver 120 through a level shifter (omitted in FIG. 1) to drive the gate driver 120. The data timing control signal DDC may be encoded into a control data packet by the timing controller 130 and transmitted to the data driver 110. Video data packets including control data packets and pixel data may be transmitted to the data driver 110 in the form of differential signals through the same wires. The gate timing control signal GDC may include at least a polarity control signal POL and a source output enable signal SOE. The source output enable signal SOE controls the output timing and charge sharing of the data driver 110.

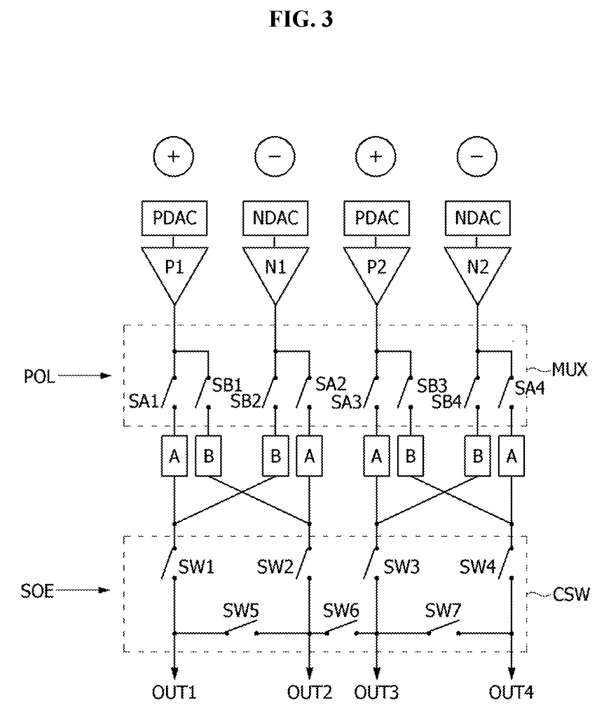

The data driver 110 includes a shift register, a latch, a digital-to-analog converter (hereinafter referred to as 'DAC'), an output buffer, and the like. The data driver 110 converts pixel data of input images received serially from the timing controller 130 into a parallel system using the shift register and the latch, and then inputs them to first and second DACs (PDAC and NDAC) shown in FIG. 3. The first DAC (PDAC) converts pixel data to positive gamma compensation voltage and outputs positive data voltage. The second DAC (NDAC) converts pixel data to negative gamma compensation voltage and outputs negative data voltage. The data driver 110 may generate analog positive/negative gamma compensation voltages using a voltage divider circuit (or voltage division circuit) that distributes gamma reference voltages input from the power supply 140 and input them to the DAC. The analog positive/negative gamma compensation voltages may be interpreted as positive/negative data voltages corresponding to grayscale values of the pixel data. The data driver 110 further includes switch elements SA1 to SB4 that select the polarity of the data voltage in response to the polarity control signal POL. The data driver 110 outputs data voltage to the data lines SL in response to the source output enable signal SOE.

The gate driver 120 sequentially supplies gate pulses synchronized with data voltages output from the data driver 110 to the gate lines GL using the shift registers driven according to the gate timing control signals GDC.

The display device further includes a power supply 140. The power supply 140 adjusts the level of DC input voltage applied from the main power source of the host system 200 to output voltages necessary for driving the pixel array of the display panel 100 and the display panel drivers 110 and 120. The power supply 140 may include a DC-DC converter. The DC-DC converter may include a charge pump, regulator, buck converter, boost converter, etc. The power supply 140 may output gamma reference voltage, gate high voltage, gate low voltage, common voltage Vcom, ground voltage GND, IC power voltage VCC, etc. through the DC-DC converter. The gamma reference voltage is supplied to the data driver 110. The gate-high voltage and gate-low voltage are respectively the high voltage and low voltage of the gate pulses applied to the pixel circuits. The gate-high voltage and gate-low voltage are supplied to the level shifter and gate driver 120. The common voltage Vcom is the reference voltage of pixels commonly applied to the pixels. According to the logic value of the polarity control signal POL, positive data voltage higher than the common voltage Vcom is applied to the pixels, or negative data voltage lower than the common voltage Vcom is applied to the pixels. The IC power voltage VCC is the power voltage of integrated circuits (IC) in which circuits of the timing controller 130 and data driver 110 are embedded.

The host system 200 converts the resolution of image signals provided from video sources to match the resolution of the display panel 100 and transmits them to the timing controller 130 along with the timing signals.

The display panel drivers 110 and 120 may drive the pixels at a variable refresh rate under the control of the timing controller 130. The timing controller 130 may reduce power consumption of the display device and improve image quality by lowering the refresh rate of images displayed on the display panel 100 according to the frequency of input images or based on the results of analyzing input images. The variable refresh rate may vary the refresh driving frequency of pixels to 1 Hz, 30 Hz, 60 Hz, 120 Hz, 144 Hz, 165 Hz, 240 Hz, etc., but is not limited thereto.

The refresh driving frequency is the driving frequency of pixels generated when pixel data is written to the pixels as many times as frames per second (FPS) that changes according to the variable refresh rate. On the other hand, the skip driving frequency is the driving frequency of pixels that maintains the data voltage of pixel data charged in the previous refresh frame without writing new pixel data. Since the pixels maintain the voltage charged in the previous frame without data updates during skip driving, the power consumption generated during skip driving is significantly less than that during refresh driving.

The unit of the variable refresh rate is Hertz (Hz). When the refresh rate is 60Hz, pixel data is written to the pixels every frame period of 60 frames per second, and when the refresh rate increases to 120Hz, pixel data is written to the pixels every frame period of 120 frames per second. In a display device that supports a variable refresh rate, the refresh driving frequency of the pixels that write pixel data to the pixels changes according to the variable refresh rate.

The display panel drivers 110 and 120, under the control of the timing controller 130, may reduce the power consumption of the display device by reducing the refresh rate of pixels when still images are input for a certain time or longer and may implement image quality optimized for the content of input images by increasing the refresh driving frequency of pixels according to the refresh rate of input images. The refresh rate may be reduced when the display device operates in standby mode or in response to user commands. Also, the refresh rate may be reduced in AOD (Always On Display) screens. The AOD screen may be a partial pixel area of the display area in which brief information such as battery remaining level or time is displayed in standby mode.

In the case of liquid crystal display devices, the polarity of data voltages applied to pixels is inverted to prevent DC bias of pixels, afterimage, etc. Polarity inversion methods include dot inversion, column inversion, line inversion, frame inversion, etc. Two or more of these inversion methods may be applied together.

FIG. 3 is an equivalent circuit diagram showing an example of the data driver 110 shown in FIG. 1. In FIG. 3, '+' denotes positive polarity and '-' denotes negative polarity.

Referring to FIG. 3, the data driver includes a plurality of first DACs (PDAC), a plurality of second DACs (NDAC), output buffers P1 to N2 electrically connected to output terminals of the DACs (PDAC and NDAC), a polarity switching part MUX that switches data voltage paths in response to the polarity control signal POL, and an output switching part CSW that outputs data voltage in response to the source output enable signal SOE. Each of the polarity switching part MUX and the output switching part CSW may be implemented as a multiplexer including multiple switch elements, but is not limited thereto.

The first DAC (PDAC) converts pixel data into a positive gamma compensation voltage to output a positive data voltage. The second DAC (NDAC) converts pixel data into a negative gamma compensation voltage to output a negative data voltage. The output voltages of the DACs (PDAC and NDAC) are input to the polarity switching part MUX through the corresponding output buffers P1 to N2.

The polarity switching part MUX switches the path of positive/negative data voltage according to the logic value of the polarity control signal POL. The polarity switching part MUX includes a plurality of 'A' switch elements SA1 to SA4 and a plurality of 'B' switch elements SB1 to SB4. The switch elements SA1 to SB4 may be implemented as transistors that are turned on/off in response to the polarity control signal POL.

The A switch elements SA1 to SA4 may be turned on in response to a first logic value of the polarity control signal POL, for example, high voltage, and turned off in response to a second logic value of the polarity control signal POL, for example, low voltage. The B switch elements SB1 to SB4 may be turned on in response to the second logic value of the polarity control signal POL and turned off in response to the first logic value of the polarity control signal POL.

The A switch elements SA1to SA4 and the B switch elements SB1to SB4 may be alternately driven in frame period units to cause the polarity of sub-pixels to be inverted on a per-frame period basis.

For example, the A switch elements SA1 to SA4 may be turned on during the first frame period to output data voltage through output terminals electrically connected to the path A. As a result, during the first frame period, a first positive data voltage is output through the first output terminal OUT1, and a second positive data voltage is output through the third output terminal OUT3. At the same time, the first negative data voltage is output through the second output terminal OUT2, and the second negative data voltage is output through the fourth output terminal OUT4.

The B switch elements SB1 to SB4 may be turned on during the second frame period to output data voltage through output terminals electrically connected to the path B. As a result, during the second frame period, the first positive data voltage is output through the second output terminal OUT2, and the second positive data voltage is output through the fourth output terminal OUT4. At the same time, the first negative data voltage is output through the first output terminal OUT1, and the second negative data voltage is output through the third output terminal OUT3.

Therefore, the data driver may invert the polarity of data voltage output through the odd-numbered output terminals OUT1 and OUT3 and the polarity of data voltage output through the even-numbered output terminals OUT2 and OUT4 in response to the polarity control signal POL during frame periods in which pixel data is updated in sub-display areas (or pixel areas) driven at a low refresh rate.

The output switching part CSW may include a plurality of switch elements SW1 to SW7 that transfer the positive/negative data voltages to the output terminals OUT1 to OUT4 or short-circuit the output terminals OUT1 to OUT4 neighboring each other according to the logic value of the source output enable signal SOE. The switch elements SW1 to SW7 may be implemented as transistors that are turned on/off in response to the logic value of the source output enable signal SOE. The pulse period of the source output enable signal SOE may be one horizontal period. The pulse voltage of the source output enable signal SOE may be a high voltage. The first to fourth switch elements SW1 to SW4 may be turned on in response to a low voltage of the source output enable signal SOE to supply the positive/negative data voltage to the corresponding output terminals OUT1 to OUT4. The fifth to seventh switch elements SW5 to SW7 are turned on in response to a high voltage of the source output enable signal SOE to short-circuit the neighboring output terminals OUT1 to OUT4. This may allow the voltages of output terminals OUT1 to OUT4 to be averaged to reduce the transition width when the polarity of data voltage applied to the data lines is inverted, thereby reducing power consumption.

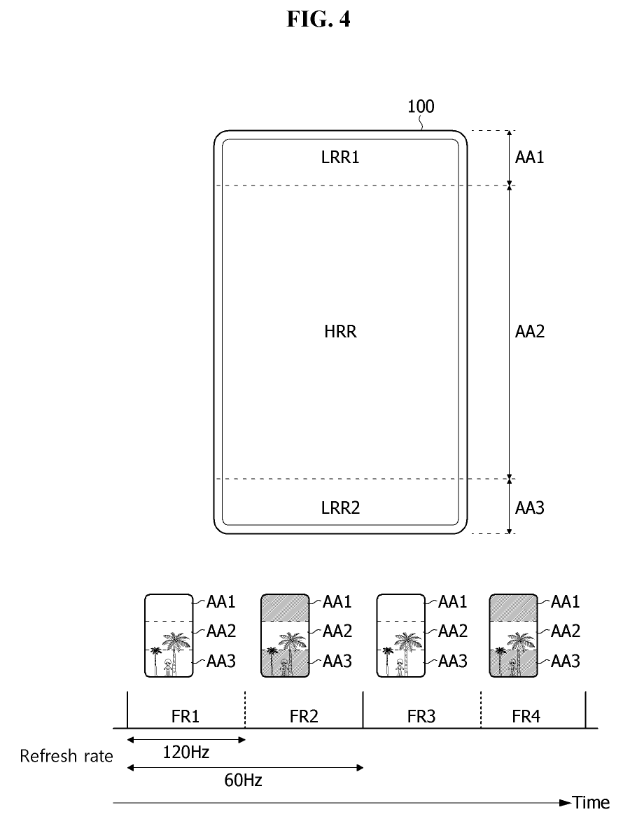

FIG. 4 is a diagram showing an example where pixels are driven at multiple frequencies when one frame image signal is displayed on the screen of a display panel.

Referring to FIG. 4, the screen of the display panel 100 may be divided into sub-display areas AA1, AA2, and AA3 having different refresh rates. The sub-display areas AA1, AA2, and AA3 refer to local pixel areas where the driving frequencies of the pixels are independently controlled without being physically separated. The sub-display areas AA1, AA2, and AA3 include pixels and signal wires of substantially the same structure.

The timing controller 130 may control each of the sub-display areas AA1, AA2, and AA3 as refresh areas or skip areas. The timing controller 130 may determine the refresh rate of input images in real time and vary the size and position of sub-display areas AA1, AA2, and AA3 every frame period. Upper and lower portions of the input images may be reproduced at a low refresh rate LRR1 (or LRR2), for example 60Hz, in the first and third sub-display areas AA1 and AA3. The central portion of the input images may be reproduced at a high refresh rate HRR, for example 120Hz, in the second sub-display area AA2. The refresh rates of the first sub-display area AA1 and the third sub-display area AA3 may be the same or different from each other.

In the example of FIG. 4, the pixels of the first sub-display area AA1 are refresh-driven during the first and third frame periods FR1 and FR3, while skip-driven during the second and fourth frame periods FR2 and FR4. The pixels of the second sub-display area AA2 are refresh-driven every frame period during the first to fourth frame periods FR1, FR2, FR3, and FR4. In an embodiment, the refresh rate of the sub-display areas is not limited to FIG. 4. For example, the refresh rate of the sub-display areas AA1, AA2, and AA3 may be one of 1 Hz, 30 Hz, 60 Hz, 120 Hz, 144 Hz, 165 Hz, and 240 Hz.

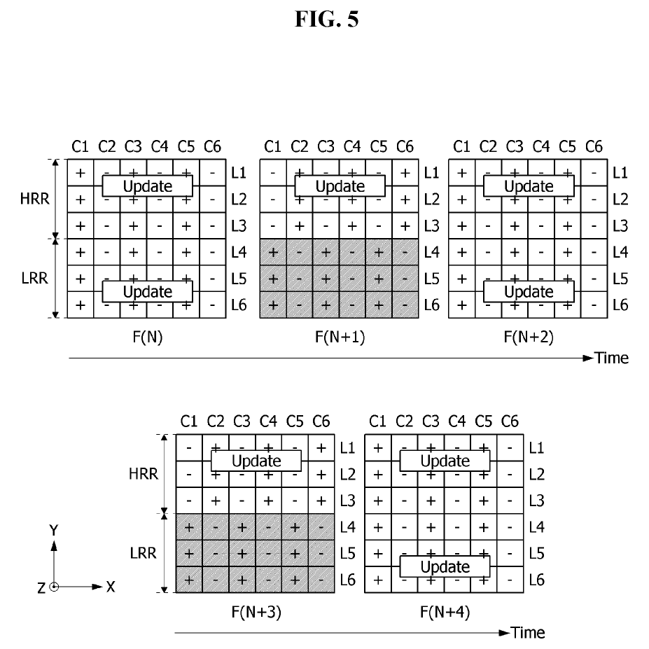

FIG. 5 is a diagram showing a polarity control method according to one embodiment of the invention. In FIG. 5, ”L1 to L6” are the numbers of pixel lines in the X-axis direction, and ”C1 to C6” are numbers of pixel columns in the Y-axis direction. In sub-display areas marked as ”Update”, the data voltage of new pixel data is charged to the pixels in the corresponding frame, thereby updating the pixel data in those pixels. ”F(N) to F(N+4)” represent Nth to (N+4)-th frame periods (N is a natural number). Hereinafter, embodiments will be described assuming F(N), F(N+2), and F(N+4) as odd-numbered frame periods, and F(N+1) and F(N+3) as even-numbered frame periods.

Referring to FIG. 5, the polarity of the pixels of the display panel 100 may be controlled by column inversion. For example, during the odd-numbered frame periods F(N), F(N+2), and F(N+4), a positive polarity data voltage (+) may be charged to the sub-pixels arranged along the odd-numbered pixel columns C1, C3, and C5, and a negative polarity data voltage (-) may be charged to the sub-pixels arranged along the even-numbered pixel columns C2, C4, and C6. The polarity of the sub-pixels may be inverted every frame period. During the even-numbered frame periods F(N+1) and F(N+3), the negative polarity data voltage (-) may be charged to the sub-pixels arranged along the odd-numbered pixel columns C1, C3, and C5, and the positive polarity data voltage (+) may be charged to the sub-pixels arranged along the even-numbered pixel columns C2, C4, and C6.

The timing controller 130 may invert the polarity of pixels arranged in the sub-display areas where pixel data is written every frame period, and maintain the polarity of pixels arranged in other sub-display areas where pixel data is not written. In this case, the polarity inversion frequency of pixels may be different between the sub-display areas having different refresh rates. For example, the polarity inversion frequency of pixels at a high refresh rate HRR is high according to the refresh rate, but the polarity inversion frequency of pixels at a low refresh rate LRR may be relatively low. Such polarity inversion differences between the pixels may cause luminance differences.

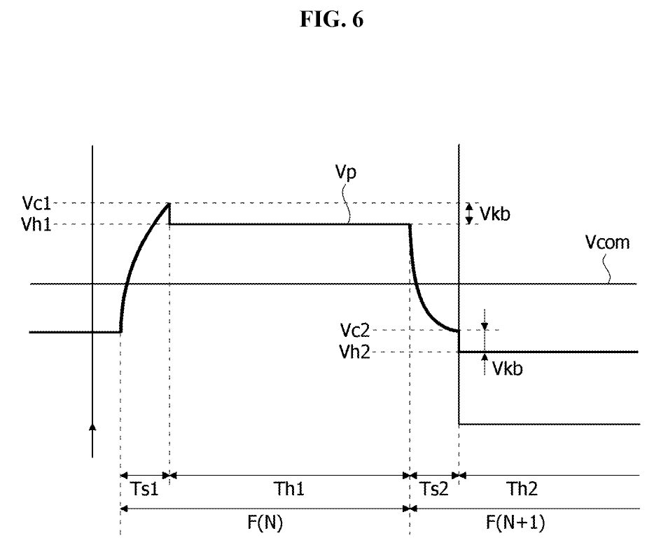

Due to the difference in kickback voltage, as shown in FIG. 6, which depends on the polarity of the data voltage charged to the sub-pixels, the charging amount of the sub-pixels varies, potentially causing a luminance difference even at the same grayscale level.

FIG. 6 is a timing diagram showing an example where the polarity of data voltage is inverted every frame period. In FIG. 6, ”Vp” denotes the voltage charged to sub-pixels.

Referring to FIG. 6, when a positive data voltage is applied to the sub-pixels, the voltage Vp of the sub-pixels rises to reach Vc1 during the first charging period Ts1, then decreases by the kickback voltage Vkb and is maintained at Vh1. When a negative data voltage is applied to the sub-pixels, the voltage Vp of the sub-pixels falls to reach Vc2 during the second charging period Ts2, and then decreases further by the kickback voltage Vkb and is maintained at Vh2. Therefore, when data voltages corresponding to pixel data of the same grayscale are charged to sub-display areas having different polarities within one screen, the amount of charge in the sub-pixels varies. When the polarity inversion frequency of pixels within one screen is the same, luminance differences are not perceived within that screen. In contrast, when sub-display areas having different polarity inversion frequencies of pixels exist together within one frame period, luminance differences may be visible in the form of blocks or lines within the screen.

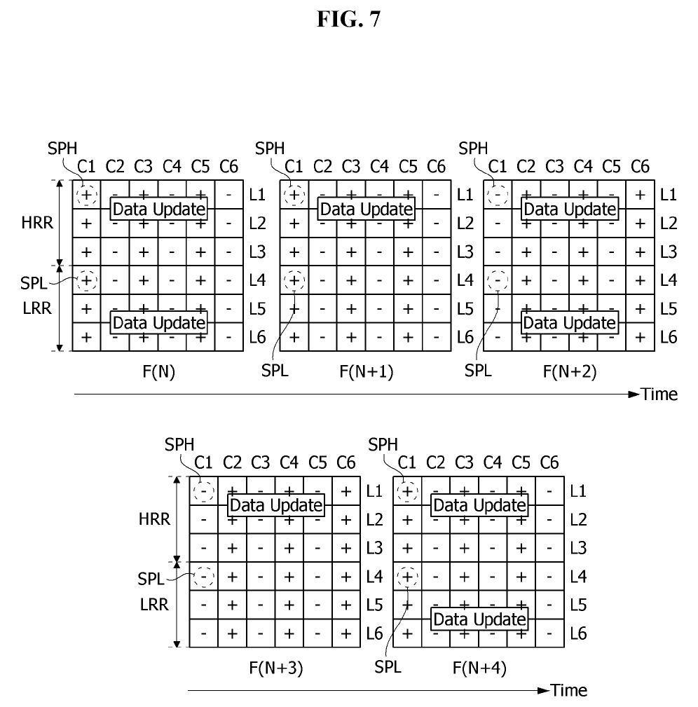

FIG. 7 is a diagram showing a polarity control method according to another embodiment of the invention. In FIG. 7, descriptions overlapping with the aforementioned embodiments are omitted. In FIG. 7, the sub-display areas driven at a high refresh rate HRR are referred to as the ”high refresh rate pixel areas HRR”, and the sub-display areas driven at a low refresh rate LRR are referred to as the ”low refresh rate pixel areas LRR”. In this embodiment, the polarity control method of representative sub-pixels SPH and SPL arranged in the first pixel column C1 in high refresh rate pixel areas and low refresh rate pixel areas respectively will be mainly described. The polarity of other sub-pixels in the odd-numbered pixel columns C1, C3, and C5, which are omitted from the description, may be controlled to have opposite polarity to the even-numbered pixel columns C2, C4, and C6.

Referring to FIG. 7, the timing controller 130 simultaneously inverts the pixel polarity of the high refresh rate pixel area HRR together with the low refresh rate pixel area LRR during frame periods when pixel data is written to the pixels of the low refresh rate pixel area LRR. The pixel polarity is controlled by the timing controller 130. The polarity of sub-pixels charged with a positive polarity data voltage is positive (+). The polarity of sub-pixels charged with a negative polarity data voltage is negative (-).

During the N-th frame period F(N), a positive polarity data voltage is charged to the pixels in the high refresh rate pixel area HRR and the low refresh rate pixel area LRR, updating the pixel data. In the N-th frame period F(N), the polarity of a first sub-pixel SPH of the high refresh rate pixel area HRR and a sub-pixel SPL of the low refresh rate pixel area LRR is positive (+). During the (N+1)-th frame period F(N+1), a positive polarity data voltage is charged to the pixels in the high refresh rate pixel area HRR, updating the pixel data, whereas the pixels in the low refresh rate pixel area LRR do not update their pixel data and maintain the previously charged data voltage. In (N+1)-th frame period F(N+1), the polarity of pixels of high refresh rate pixel area HRR and low refresh rate pixel area LRR is not inverted but instead maintained. Therefore, the polarity of the first and second sub-pixels SPH and SPL remains positive (+) in the (N+1)-th frame period F(N+1), the same as in the previous frame period F(N).

Subsequently, during the (N+2)-th frame period F(N+2), a negative polarity data voltage is charged to the pixels in the high refresh rate pixel area HRR and the low refresh rate pixel area LRR, updating the pixel data. In the (N+2)-th frame period F(N+2), the polarity of the first sub-pixel SPH in the high refresh rate pixel area HRR and the sub-pixel SPL in the low refresh rate pixel area LRR is negative (-). During the (N+3)-th frame period F(N+3), a negative polarity data voltage is charged to the pixels of the high refresh rate pixel area HRR, updating the pixel data, whereas the pixels in the low refresh rate pixel area LRR do not update their pixel data and maintain the previously charged data voltage. In the (N+3)-th frame period F(N+3), the polarity of the pixels in the high refresh rate pixel area HRR and the low refresh rate pixel area LRR is maintained. Therefore, the polarity of the first and second sub-pixels SPH and SPL is negative in the (N+3)-th frame period F(N+3), the same as in the previous frame period F(N+2).

As shown in FIG. 7, when the pixel data is written to the pixels in the low refresh rate pixel area LRR, the pixel polarity of the high refresh rate pixel area HRR is also inverted simultaneously with the inversion of the pixel polarity of the low refresh rate pixel area LRR. As a result, the polarity may be controlled identically in the pixel areas having different refresh rates within one frame period of one screen.

The polarity control method shown in FIG. 7 may control the polarity inversion frequency of the pixels between the pixel areas having different refresh rates identically when viewed on the time axis. Therefore, embodiments of the invention may implement uniform quality images without luminance differences when controlling the pixel driving frequency differently for each pixel area at a variable refresh rate within one screen.

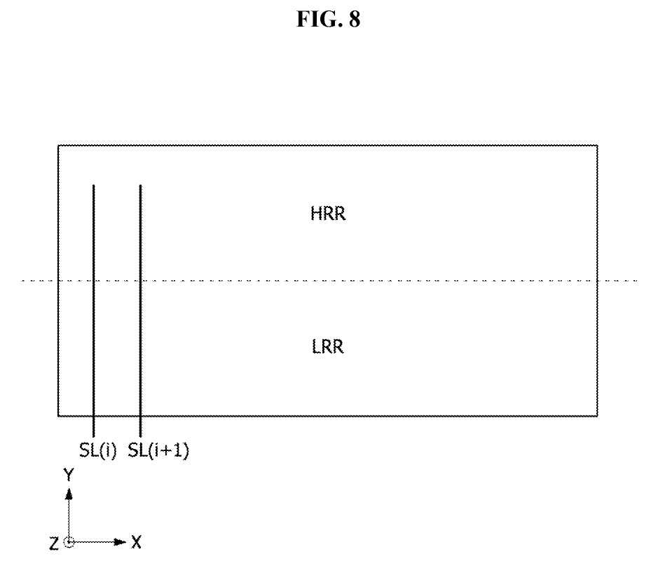

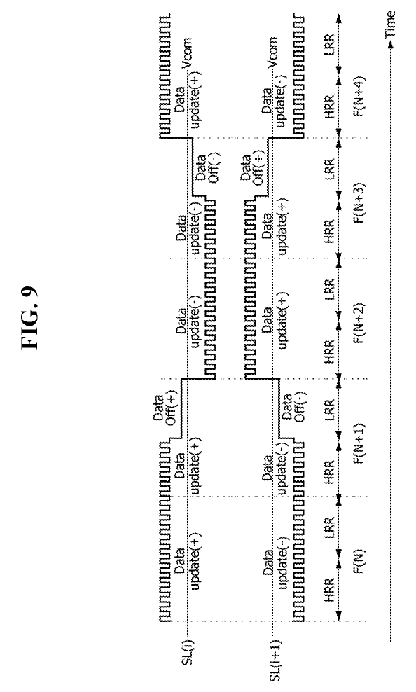

FIGS. 8 and 9 are diagrams showing an example of data voltage waveforms applied to the data lines in the polarity control method shown in FIG. 7. FIG. 8 is a diagram schematically showing the i-th (i is a natural number) and the (i+1)-th data lines SL(i), SL(i+1) crossing the high refresh rate pixel area HRR and the low refresh rate pixel area LRR. FIG. 9 is a diagram showing an example of data voltage applied to the i-th and the (i+1)-th data lines SL(i) and SL(i+1) in the variable refresh rate and the polarity control method shown in FIG. 7.

Referring to FIGS. 7, 8, and 9, the data driver 110 outputs data voltage with polarity selected according to the logic value of the polarity control signal received from the timing controller 130. When the pixel data is not updated in the low refresh rate pixel area LRR, for example, during the skip periods of the (N+1)-th and the (N+3)-th frame periods F(N+1) and F(N+3), the data driver 110 may not output data voltage and the gate driver 120 may not output gate pulses. Therefore, power consumption of the display panel drivers 110 and 120 is minimal during the skip periods of the low refresh rate pixel area LRR.

During the N-th frame period F(N), the pixels in the high refresh rate pixel area HRR and the low refresh rate pixel area LRR are refresh-driven. During the N-th frame period F(N), a positive polarity data voltage is applied to the i-th data line SL(i), and a negative polarity data voltage is applied to the (i+1)th data line SL(i+1).

In the (N+1)-th frame period F(N+1), the pixels in the high refresh rate pixel area HRR are refresh-driven during the refresh period, pixel data is updated in the high refresh rate pixel area HRR. The pixels in the low refresh rate pixel area LRR are skip-driven during the (N+1)-th frame period F(N+1), and pixel data is not updated for the pixels in the low refresh rate pixel area LRR. The data voltage is not output from the data driver 110 during the skip period of the (N+1)-th frame period F(N+1). During the refresh period of the (N+1)-th frame period F(N+1), a positive polarity data voltage is applied to the i-th data line SL(i), and a negative polarity data voltage is applied to the (i+1)-th data line SL(i+1). Subsequently, during the skip period of the (N+1)-th frame period F(N+1), no data voltage is applied to the i-th data line SL(i) and the (i+1)-th data line SL(i+1). During the skip period of the (N+1)-th frame period F(N+1), the voltage of the data lines SL(i) and SL(i+1) may be a positive charge-share voltage or the data lines SL(i) and SL(i+1) may be electrically separated from the output terminals of the data driver 110 and left floating.

During the (N+2)-th frame period F(N+2), the pixels in the high refresh rate pixel area HRR and the low refresh rate pixel area LRR are refresh-driven. The timing controller 130 inverts the pixel polarity by inverting the logic value of the polarity control signal when the pixel data is updated in the low refresh rate pixel area LRR. During the (N+2)-th frame period F(N+2), a negative polarity data voltage is applied to the i-th data line SL(i), and a positive polarity data voltage is applied to the (i+1)th data line SL(i+1).

In the (N+3)-th frame period F(N+3), the pixel data is updated in the high refresh rate pixel area HRR during the refresh period in the high refresh rate pixel area HRR. The pixels in the low refresh rate pixel area LRR are skip-driven during the (N+3)-th frame period F(N+3), and the pixel data is not updated for the pixels in the low refresh rate pixel area LRR. During the refresh period of the (N+3)-th frame period F(N+3), a negative polarity data voltage is applied to the i-th data line SL(i), and a positive polarity data voltage is applied to the (i+1)-th data line SL(i+1). Subsequently, during the skip period of the (N+3)-th frame period F(N+3), no data voltage is applied to the i-th data line SL(i) and the (i+1)-th data line SL(i+1). During the skip period of the (N+3)-th frame period F(N+3), the voltage of the data lines SL(i) and SL(i+1) may be a negative charge-share voltage, or the data lines (SL(i), SL(i+1)) may be left floating.

According to one or more embodiments of the invention, the display device may be applied to mobile devices, video phones, smart watches, watch phones, wearable device, foldable device, rollable device, bendable device, flexible device, curved device, sliding device, variable device, electronic organizer, electronic books, portable multimedia players (PMPs), personal digital assistants (PDAs), MP3 players, mobile medical devices, desktop PCs, laptop PCs, netbook computers, workstations, navigations, vehicle navigations, vehicle display devices, vehicle devices, theater devices, theater display devices, televisions, wallpaper devices, signage devices, game devices, laptops, monitors, cameras, camcorders, and home appliances, etc. Additionally, the display apparatus according to one or more embodiments of the invention may be applied to organic light emitting lighting devices or inorganic light emitting lighting devices.

The embodiments of the invention can reduce power consumption of a display device without degrading image quality of images reproduced on the screen by inverting pixel polarity of sub-display areas or pixel areas having different refresh rates within one screen according to the pixel data update period of a low refresh rate.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A display device comprising:
a display panel including a plurality of data lines, a plurality of gate lines, and a plurality of pixels;
a data driver electrically connected to the plurality of data lines and configured to output a data voltage having a polarity indicated by a polarity control signal;
a gate driver electrically connected to the plurality of gate lines and configured to output a gate pulse synchronized with the data voltage; and
a timing controller configured to control operation timing of the data driver and the gate driver, and to generate the polarity control signal to control polarities of the plurality of pixels,
wherein the display panel comprises:
a first pixel area configured to display an image at a first refresh rate; and
a second pixel area configured to display an image at a second refresh rate lower than the first refresh rate, and
wherein during a frame period in which pixel data is updated for the pixels in the second pixel area, the polarity of the data voltage is inverted, causing the polarities of the pixels in the first pixel area and the pixels in the second pixel area to be inverted.

2. The display device of claim 1, wherein, during a frame period in which pixel data is updated for the pixels in the second pixel area, the polarities of the pixels in the first pixel area and the pixels in the second pixel area are inverted.

3. The display device of claim 1, wherein, during a frame period in which pixel data is updated for the pixels in the first pixel area and the second pixel area, the polarities of the pixels in the first pixel area and the second pixel area are maintained.

4. The display device of claim 1, wherein, during a frame period in which pixel data is updated only in the first pixel area, the polarities of the pixels in the first pixel area and the second pixel area are maintained.

5. The display device of claim 1, wherein the data driver is configured to:
output the data voltage during a refresh period of a frame period in which pixel data is updated in the first pixel area and the second pixel area; and
not output the data voltage during a skip period in which pixel data is not updated.

6. The display device of claim 1, wherein the data driver is configured to:
output the data voltage having a first polarity through odd-numbered output terminals and output the data voltage having a second polarity through even-numbered output terminals; and
invert the polarity of the data voltage output through the odd-numbered output terminals and the polarity of the data voltage output through the even-numbered output terminals in response to the polarity control signal during the frame periods in which pixel data is updated for the pixels in the second pixel area.

7. The display device of claim 1, wherein a driving frequency of pixels arranged in the second pixel area is less than a driving frequency of pixels arranged in the first pixel area.

8. The display device of claim 1, wherein a polarity inversion frequency of pixels arranged in the second pixel area is substantially equal to a polarity inversion frequency of pixels arranged in the first pixel area.

9. The display device of claim 1, wherein the plurality of pixels include liquid crystal.

10. The display device of claim 1, wherein frequencies of the first refresh rate and the second refresh rate are different from each other.

11. A method of driving a display device, the method comprising:
driving pixels in a first pixel area of a screen of the display device at a first driving frequency to display images in the first pixel area at a first refresh rate;
driving pixels of a second pixel area of the screen at a second driving frequency to display images in the second pixel area at a second refresh rate lower than the first refresh rate; and
inverting polarities of the pixels in the first pixel area and the pixels in the second pixel area during a frame period in which pixel data is updated for the pixels in the second pixel area.

12. The method of claim 11, further comprising maintaining polarities of the pixels in the first pixel area and the second pixel area during another frame period in which pixel data is updated for the pixels in the first pixel area and the second pixel area.

13. The method of claim 12, further comprising maintaining polarities of the pixels in the first pixel area and the second pixel area during a frame period in which pixel data is updated only in the first pixel area.

14. The method of claim 11, further comprising:
outputting a data voltage from a data driver of the display device during a refresh period of a frame period in which the pixel data is updated in the first pixel area and the second pixel area; and
controlling the data driver so that the data voltage is not output from the data driver during a skip period in which the pixel data is not updated.

15. The method of claim 11, further comprising controlling a driving frequency of the pixels arranged in the second pixel area to be less than a driving frequency of the pixels arranged in the first pixel area.

16. The method of claim 11, further comprising controlling a polarity inversion frequency of the pixels arranged in the second pixel area to be substantially equal to a polarity inversion frequency of the pixels arranged in the first pixel area.
